(19) United States
(12) Patent Application Publication
(10) Pub. No.: US 2025/0123443 A1
(43) Pub. Date: Apr. 17, 2025

(54) Large-aperture Flat Light Collector

(71) Applicant: The Charles Stark Draper Laboratory, Inc., Cambridge, MA (US)

(72) Inventors: Ryan J. Gelly, Weymouth, MA (US); Lucas D. Benney, Brighton, MA (US); Steven J. Spector, Lexington, MA (US); Joseph Hollmann, Cambridge, MA (US); Michael G. Moebius, Arlington, MA (US)

(21) Appl. No.: 18/915,806

(22) Filed: Oct. 15, 2024

Related U.S. Application Data
(60) Provisional application No. 63/590,131, filed on Oct. 13, 2023.

(51) Int. Cl. G02B 6/32; G02B 6/12; G02B 6/293

(52) U.S. Cl. CPC G02B 6/32; G02B 6/12004; G02B 6/29305; G02B 6/29331; G02B 6/29346; G02B 2006/12102; G02B 2006/12104; G02B 2006/12123

(57) ABSTRACT

A system includes an array of light-collecting elements, each light-collecting element of the array of light-collecting elements configured to output a collected light signal to an optical fiber of a number of optical fibers, an optical fiber combiner coupled to the array of light-collecting elements by the number of optical fibers, the optical fiber combiner configured to receive the collected light signals from the array of light-collecting elements through the number of optical fibers and to combine the collected light signals to form one or more combined collected light signals, and an optical detector configured to receive the one or more combined collected light signals from the optical fiber combiner and convert the one or more combined light signals into one or more electrical signals.

### CROSS-REFERENCES TO RELATED APPLICATIONS

This application claims the benefit of U.S. Provisional Application No. 63/590,131 filed Oct. 13, 2023, the entire contents of which are incorporated herein by reference.

### FIELD OF DISCLOSURE

The present disclosure relates generally to photonic devices, more particularly to systems and methods for collecting optical signals from a distance using a synthesized large-aperture, flat light collector.

### BACKGROUND

When optical signals need to be collected in scenarios with low numbers of photons, i.e., weak optical signals traveling from great distances, a large collecting aperture is needed to achieve an acceptable signal-to-noise ratio. A typical large-aperture system, such as a telescope, can weigh tens to hundreds of pounds and can be meters in length. The large size of such devices is due to the use of bulk optics which are both heavy and large, typically having a fixed ratio of focal length to diameter. The large and heavy optics increase the system volume as the aperture increases. Disadvantageously, such systems cannot be deployed in applications where low size, weight, and power is desired, for example, in space or other environments where size, weight, and power need to be minimized. Moreover, the conservation of etendue sets a strict relationship between the field of view and the optic aperture which limits the field of view for a given detector size.

### SUMMARY

In accordance with the concepts described herein, described here are exemplary devices and structures directed toward synthesizing a large-aperture, flat light collector using photonic integrated circuits. The photonic integrated circuits may comprise arrayed flat, light-collecting elements that are fiber coupled to a common multimode fiber combiner which is routed to an optical detector for processing by electronics. The light-collecting elements may include one or more micro-lens arrays coupled to photonic integrated circuits and optical fiber.

According to one aspect, a system may include an array of light-collecting elements, a fiber combiner, and one or more optical fibers coupled between the array of light-collecting elements and the fiber combiner. A detector, possibly having single-photon sensitivity, may be coupled to receive optical signals from the fiber or fiber combiner.

In a general aspect, a system includes an array of light-collecting elements, each light-collecting element of the array of light-collecting elements configured to output a collected light signal to an optical fiber of a number of optical fibers, an optical fiber combiner coupled to the array of light-collecting elements by the number of optical fibers, the optical fiber combiner configured to receive the collected light signals from the array of light-collecting elements through the number of optical fibers and to combine the collected light signals to form one or more combined collected light signals, and an optical detector configured to receive the one or more combined collected light signals from the optical fiber combiner and convert the one or more combined light signals into one or more electrical signals.

Aspects may include one or more of the following features.

Each light-collecting element may include a number of unit cells, each unit cell including a lens and a waveguide in-coupler for optically coupling the lens to a unit cell waveguide. Each light-collecting element may include a bus waveguide and a waveguide coupler configured to optically couple the unit cell waveguides of the number of unit cells to the bus waveguide. The waveguide coupler may coherently couple at least some of the unit cell waveguides of the number of unit cells to the bus waveguide. Each light-collecting element may include a fiber coupling for coupling the light-collecting element's bus waveguide to an optical fiber.

The optical fiber combiner may incoherently combine the collected light signals to form the one or more combined collected light signals. Each light-collecting element may include an array of micro-lenses and a photonic integrated circuit coupled to the micro-lens array. The photonic integrated circuit may include an upper cladding layer, a waveguide layer, a lower cladding layer, and a substrate. The array of micro-lenses may have an anti-reflective coating disposed thereon. The optical fiber combiner may be a multimode fiber combiner. The optical detector may include a single-photon sensitive detector. The detector may include a photo-diode.

Each lens may have an aperture diameter and the system may be configured to synthesize a large aperture with a diameter equal to a sum of the aperture diameters of the lenses. A field of view of the system, the diameter of the synthesized large aperture, and the detector area may be decoupled.

The waveguide in-coupler may include a micro-mirror coupler. The waveguide in-coupler may include a grating coupler. The waveguide coupler may include a multimode interferometer. The waveguide coupler may include an evanescent waveguide coupler. The system may include a processor configured to process the one or more electrical signals to generate image data. Each light-collecting element may have a substantially planar shape.

### BRIEF DESCRIPTION OF THE DRAWINGS

FIG. 1 is a light collection system.

FIG. 2 is a light-collecting element.

FIG. 3 is a flow diagram of the operation of the light collection system.

FIG. 4 is a hierarchical block diagram of the light collection system.

FIG. 5 is a high-level, scalable hierarchy of an arrayed structure for a light collection system.

FIG. 6 is cross-sectional view of a photonic integrated circuit.

FIG. 7 is a focal length diagram.

FIG. 8a is a cross-section of a unit cell with a micro-mirror.

FIG. 8b is a top view of the unit cell of FIG. 8a.

FIG. 9a is a cross-section of a unit cell with a grating coupler.

FIG. 9b is a top view of the unit cell of FIG. 9a.

FIG. 10 is a multimode interferometer.

FIG. 11 is an evanescent waveguide coupler.

FIG. 12 is another configuration of a light-collecting system.

FIG. 13 is a first type of fiber coupling between light-collecting devices.

FIG. 14 is a second type of fiber coupling between light-collecting devices.

FIG. 15 shows two light-collecting elements disposed on reticles and coupled using a waveguide structure.

FIG. 16 shows two light-collecting elements connecting using a photonic wire bond.

### DETAILED DESCRIPTION

Aspects and embodiments disclosed herein are not limited in application to the details of construction and the arrangement of components set forth in the following description or illustrated in the drawings. Aspects and embodiments disclosed herein are capable of being practiced or of being carried out in various ways. Also, the phraseology and terminology used herein is for the purpose of description and should not be regarded as limiting. The use of “including,” “comprising,” “having,” “containing,” “involving,” and variations thereof herein are meant to encompass the items listed thereafter and equivalents thereof as well as additional items.

Aspects of the present disclosure include systems and methods for collecting weak optical signals using a synthesized large-aperture flat light collector, where field of view, detector area, and optical aperture are decoupled. As used herein, weak optical signals may be considered optical signals with an irradiance that without focusing or collecting, do not have an amplitude level detectable above a noise level of a conventional commercially available detector. According to aspects of the present disclosure, a large aperture may be described as the summed apertures of micro-lenses implemented in the system. The aperture may be large compared to the aperture of a given micro-lens, and compared to the focal length of the system. For example, a focusing element of the system (which may be the only focusing elements of the system) may have a focal length on the order of about one-millimeter, however, as described herein, the system aperture can be scaled to many tens of centimeters by cascading elements. The collector, according to one or more aspects, may include one or more arrays of light-collecting elements, a fiber combiner coupled to the one or more arrays through optical fibers and an optical detector to convert the received optical signals into electronic signals processed by additional system resources. In some examples, the additional system resources process the electronic signals to generate image data.

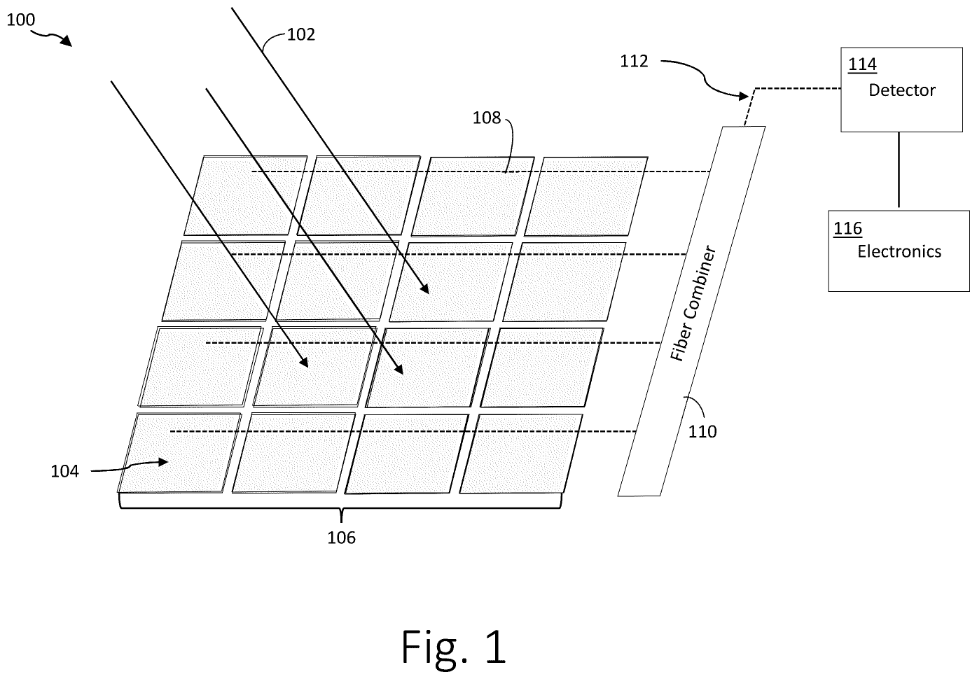

FIG. 1 depicts an abstraction of a light-collection system 100 according to one aspect of the disclosure. Generally, the system 100 may include one or more arrays 106 of light-collecting elements 104 that are coupled to a common multimode fiber combiner 110 by one or more optical signal paths 108. Optical signal paths 108 may be provided as one more optical fibers and/or one or more integrated photonic bus waveguides. The fiber combiner 110 may be coupled to an optical detector 114 via additional optical signal paths 112 (e.g., one more optical fibers and/or one or more integrated photonic bus waveguides) to convert the optical signals to electronic signals. The optical detector 114 may be further coupled to additional system electronics 116 for processing. The system electronics 116 may include one or more analog-to-digital converters, processers, computers, or other electronics adapted to receive and process signals from the detector. System electronics 116 may also comprise communications systems including but not limited to satellite communication systems.

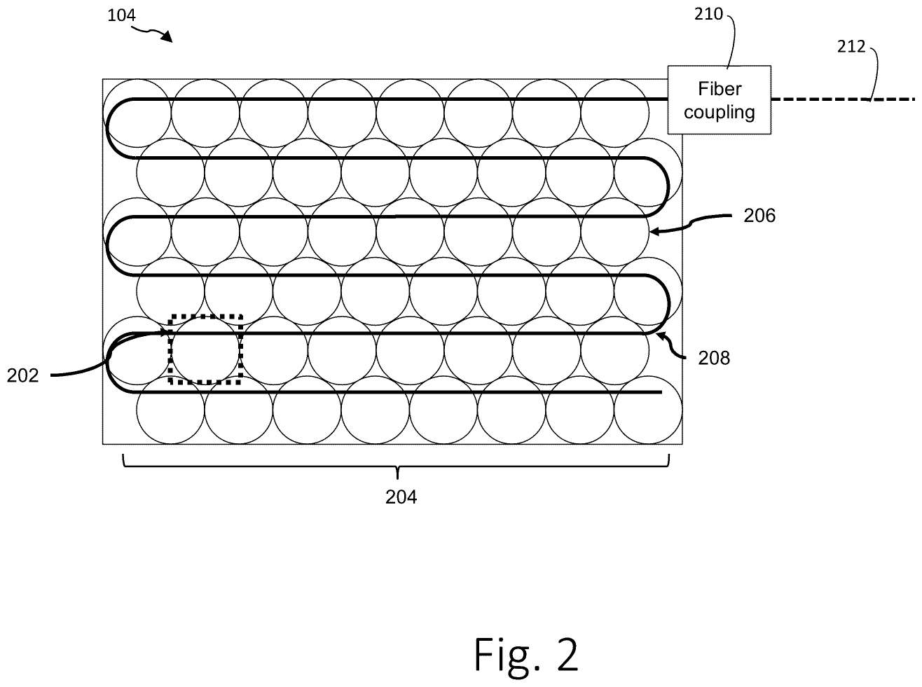

In operation, and described in more detail below, light 102 may impinge upon (or strike) the arrays 106 of light-collecting elements 104 (stated differently, arrays 106 of light-collecting elements 104 may be disposed to intercept light 102 propagating along a given path). The incident light 102 (i.e., light incident on the light-collecting elements 104) may be routed to the fiber combiner 110 via the optical path 108 (e.g., bus waveguide) where the light may be combined with light received from other light-collecting elements 104 and arrays 106. The combined light may be routed to the optical detector 114. The detector 114 may then convert the optical signals to electrical signals and communicate the received information to the system electronics 116 for additional processing. FIG. 2 depicts an abstract-view of a light-collecting element 104 at a die-level. As described in more detail below, the light-collecting elements 104 may include or be formed from two or more micro-lenses (i.e., a micro-lens array 204) coupled to photonic integrated circuits with multi-layer stacks of micro-lens arrays 204 adapted to collect and provide the collected light to an optical path 208. Optical path 208 is coupled to a fiber coupling 210. The fiber coupling 210 may have additional light-collecting elements coupled thereto through one or more optical signal paths 212 (e.g., one more optical fibers and/or one or more fiber optics bus waveguides). The fiber coupling 210 may also or instead be coupled to a detector or a fiber combiner. Incident light to the unit-cells 202 and micro-lenses 206 may be focused into the bus waveguide 208 and transmitted from the bus waveguide 208 to a fiber coupling 210 and off the light-collecting element 104. In some aspects, the bus waveguide 208 may be a single, multimode waveguide where signals transmit along its length. Accordingly, loss in the bus waveguide 208 may be kept very low. In other aspects, the bus waveguide 208 may include multiple, parallel single- or multi-mode waveguides where signals transmit along their length. Similarly, loss in the bus waveguide 208 can be kept ultra-low. Each light-collecting element 104 may be arrayed, as shown in FIG. 1, to generate a large-aperture collector.

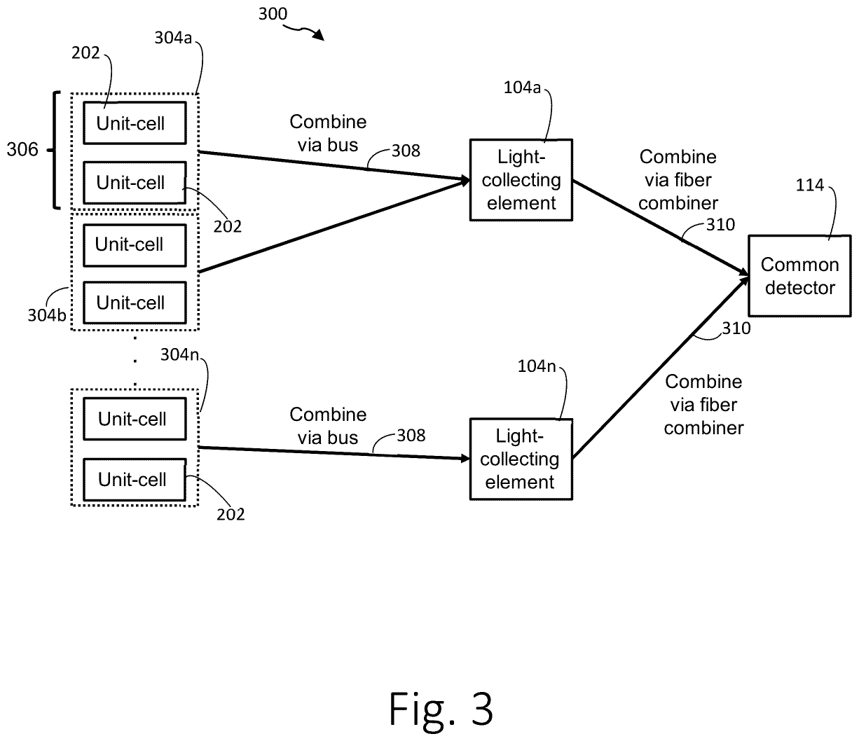

FIG. 3 depicts a hierarchical flow diagram 300 of the operation of a synthesized large-aperture collector according to certain aspects of the present disclosure. According to one aspect, a large aperture can be generated from flat components by arraying light-collecting elements 304a-n which route the incident light to a common detector 114.

For example, a light-collecting element 304a may include one or more unit-cells 202a, 202b. Each unit-cell 202 may be capable of collecting incident light and forwarding it to the detector 114. Some of the unit-cells 202 may have their inputs coherently combined, shown by bracket 306, prior to being combined by the bus waveguide 308 to reduce the total number of modes needed at the output. After any coherent combining 306, the unit-cell waveguides couple light to a multimode bus waveguide 308 that brings collected light to the edge of the die, shown as light-collecting element 104a. The bus waveguide 308 may be coupled to a multimode fiber which is then combined with other fibers via a fiber combiner 310 to array multiple flat light-collecting elements 104a-n (die), further increasing the effective aperture.

Accordingly, the total system aperture may be equal to the summed apertures of elements 304a to 304n, which is equal to the sum of the apertures of each unit cell 202, which is equal to the sum of light-collecting elements 104a to 104n. According to one aspect, as a photonic integrated circuit is scaled to a larger size, the introduced losses may grow. The losses due to coupling elements 104a to each other, however, is a constant (i.e., dictated by fiber coupling, not system size). Accordingly, the number and arrangement of elements 304(a-n) and inherent combinations 306 coupled together to form light-collecting element 104a may be chosen to optimize the tradeoff between circuit loss and outcoupling loss.

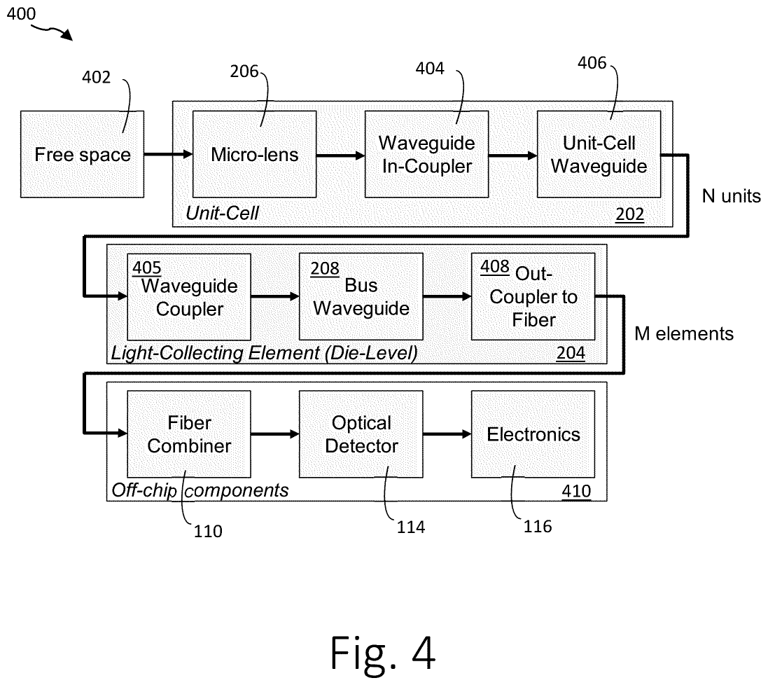

According to one aspect, the total aperture of the system may be given by:

$${T}_{A} = Ac * Nc * {M}_{D} \qquad ( 1 )$$

where, T_{A} is the total aperture, A_{C} is the area of the unit cell, N_{C} is the number of unit cells 202 per light-collecting element 104, and M_{D} is the number of arrayed light-collecting elements 104. Referring now to FIG. 4, a hierarchical block diagram of a system 400 for detecting light from free space 402 to the system electronics 116 where the information from the received light can be processed according to the needs and/or requirements of the particular system application. The units may be conceptually grouped according to their membership in either the unit-cell 202, the light-collecting element 204, or off-chip components 410. According to one aspect, these three illustrative categories represent different hierarchical levels in the arrayed structure of the system. Incident light may travel from free space 402 to the unit-cell 202 comprising a micro-lens 206, a wave guide in-coupler 404 and unit-cell waveguide 406. The waveguide in-coupler 404 may receive light from the micro-lens 206 and transmit the collected light to the unit-cell waveguide 406 where the light is transmitted off the unit-cell 202.

The light-collecting element 204 may include one or more (N units) unit cells 202. A waveguide coupler 405 may coherently combine and couple light from the N unit-cell waveguides 406 to the bus waveguide 208. An out-coupler 408 may fiber-couple the bus waveguide 208 to the off-chip components 410, including a fiber-combiner 110, optical detector 114 and system electronics 116. The fiber combiner may incoherently combine the outputs of M arrayed light-collecting elements to the optical detector 114 which may communicate the detected and converted light information to the system electronics 116.

The hierarchical structure of the components described herein provides a highly scalable arrayed structure to generate large-aperture collectors sized according to the particular application in which the collector may be used.

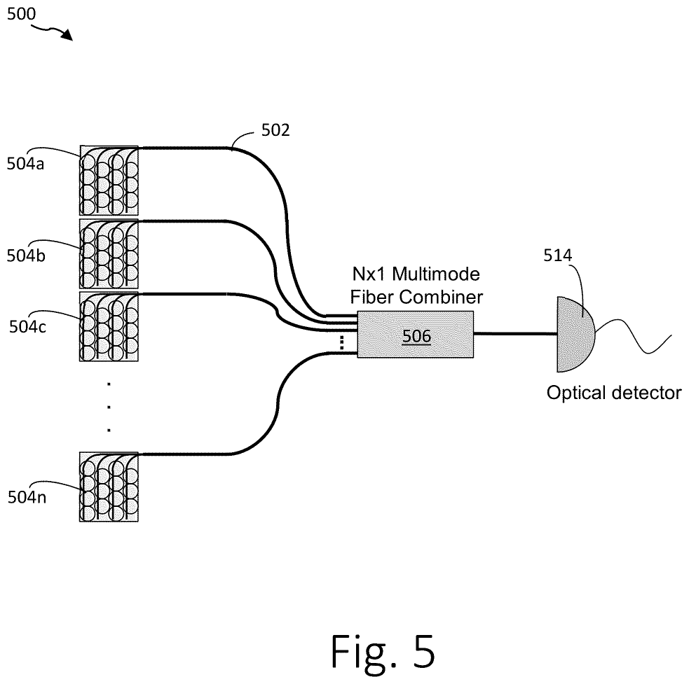

FIG. 5 depicts a high-level, scalable hierarchy 500 of an arrayed structure according to one aspect of the present disclosure. The light-collecting elements 504a-n (die scale) may be tiled, i.e., arranged in a horizontal configuration. According to one aspect, however, a specific pattern is not required. For example, the light-collecting elements 504a-n may be arranged at will across the substrate, including in a square, rectangular, round, or offset shapes/patterns and their fiber outputs 502 may be incoherently combined using a fiber combiner, for example a N×1 multimode fiber combiner 506 before reaching an optical detector 514. The ability to incoherently combine the optical outputs 502 of several arrayed light-collecting elements 504a-n creates a system that can be scaled effectively and efficiently to create a synthesized collector with an aperture size tailored to the specific application for which the collector is deployed. According to one aspect, each of the systems depicted in FIG. 5 may be designed to collect light from different solid angles whereby the detector outputs could be combined together to form an image.

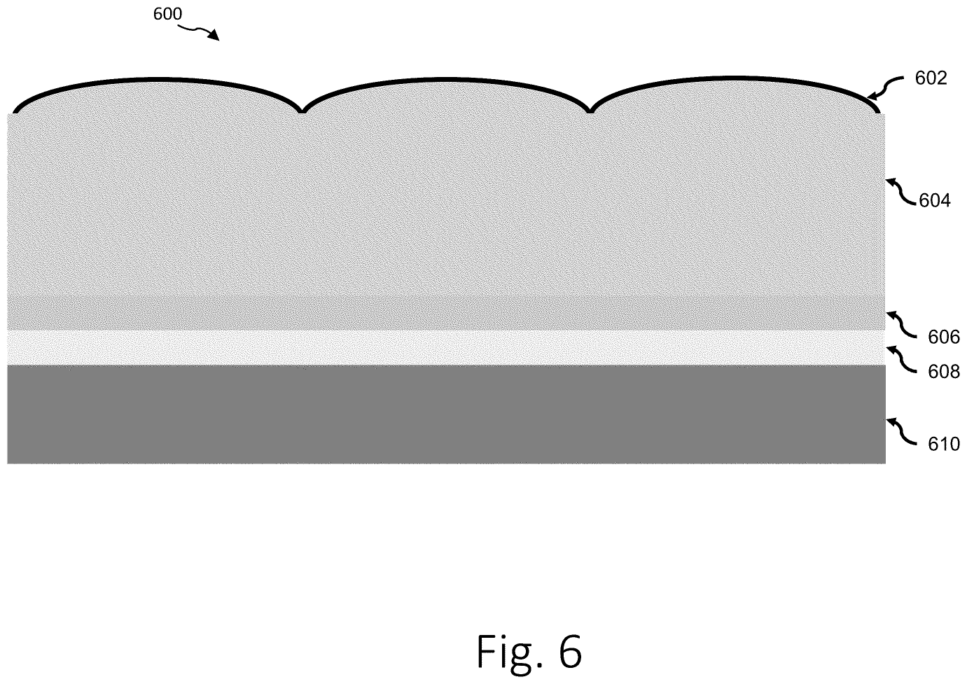

As detailed above, the light-collecting elements described herein may include micro-lens arrays coupled to photonic integrated circuits fiber-optically combined to synthesize a large aperture collector. FIG. 6 depicts a cross-sectional view of the layers of a photonic integrated circuit, such as light-collecting element die 600, according to one aspect of the present disclosure. Light-collecting element die 600, may be manufactured according to well-known integrated circuit manufacturing processes.

According to one aspect of the disclosure, a photonic integrated circuit die 600 may include an antireflective coating 602 over a micro-lens and upper cladding layer 604. As described herein, incident light may pass through the anti-reflective coating 602 where the micro-lens layer 604 may focus the light onto a waveguide layer 606 where the light will be carried to the die-edge. According to one aspect, different waveguides or guided propagation modalities may be implemented. For example, large or multi-mode waveguides may operate via total internal reflection (high index core, surrounded by low index cladding-trap rays propagating beyond the critical angle for total internal reflection).

Alternatively, single mode and multi-mode waveguides may be implemented to support eigenmodes confined to some extent within the waveguide core and some evanescent field (i.e., eigenmodes in waveguides with constant cross section or evolving modes, usually designed to evolve adiabatically to minimize loss, in waveguides with changing cross sections). A substrate 610 may support a lower cladding layer 608, below the waveguide layer 606.

The thickness and materials used for each layer may vary depending on the application in which the collector may be used. For example, for visible light applications, the antireflective coating 602 may be any thin film or nanostructured anti-reflective coating, such as magnesium fluoride or moth's eye nanotexture. The upper cladding layer 604 may be or include almost any glass or polymer, such as fused silica or polymethyl methacrylate. The waveguide layer 606 could be any material with a higher refractive index than the cladding layers, such as silicon nitride, titanium dioxide, diamond, silicon carbide, or heavily doped silicon oxide. The lower cladding 608 may be silica, oxynitride, polymeric or quartz. The substrate 610 may be silicon or quartz. Further, for ultra-violet, or infrared applications, analogous materials may be chosen that have the proper absorbance and refractive indices at those wavelengths. For example, silicon may be used as the waveguide layer for infrared shortwave and mid wave wavelengths, but not for visible wavelengths. Additionally, for mid-wave infrared applications, the waveguide may include silicon nitride, germanium, chalcogenide glasses. Cladding materials for mid-wave infrared application include may include sapphire and air clad (suspended or membrane supported ridge waveguides).

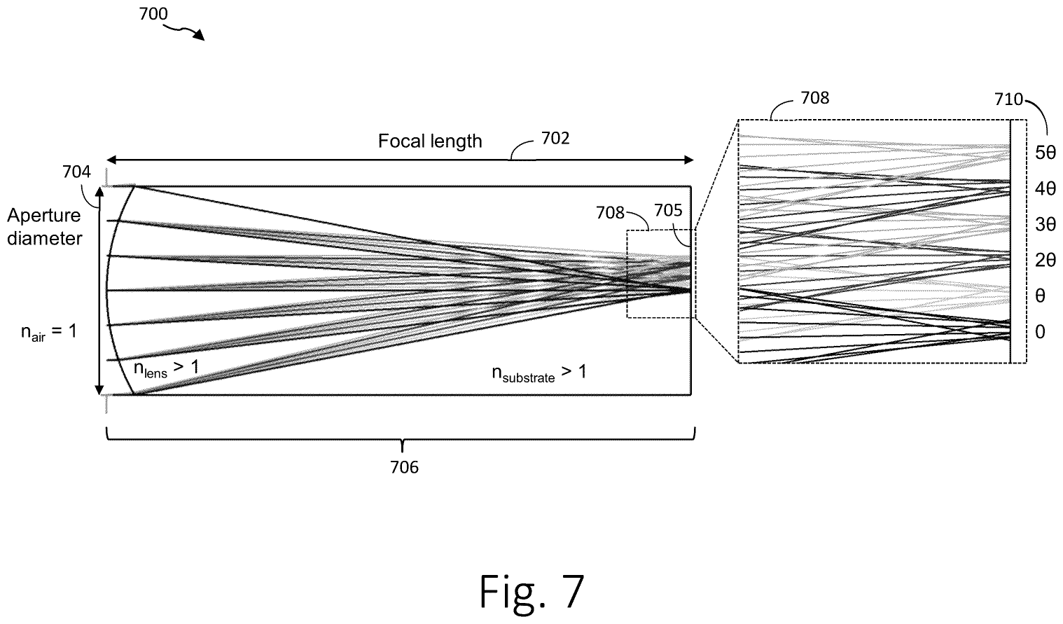

FIG. 7 depicts an exemplary focal length diagram 700 of a micro-lens layer 706 according to an aspect of the present disclosure. A micro-lens with a given aperture 704 and focal length 702, both of which may range from tens of micrometers to tens of millimeters in a given embodiment, may focus light from free space to the focal length 702. The micro-lens 706 and its cladding substrate may have refractive indices (nₗₑₙₛ, n_{substrate}) greater than one, and may be the same or different from each other. As shown in the expanded box 708, the micro-lens 706 may spatially separate light of different angles of incidence (0) 710 at the lens substrate surface 705.

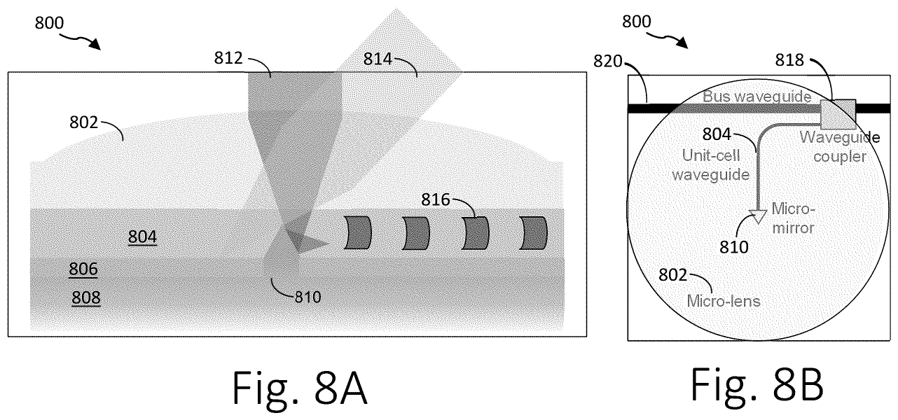

FIGS. 8A and 8B depict a cross-section (FIG. 8A) and a top-view (FIG. 8B) of a unit cell 800, according to one aspect, which may include a micro-mirror 810 to couple light to the waveguide 804. As described above, a substrate 808 may support a lower cladding 806 layer, a waveguide layer 804, and a micro-lens and upper cladding layer 802. According to one aspect, a micro-mirror 810 may couple light focused by the micro-lens 802 into the waveguide 804. The micro-mirror 810 may include a reflective, angled material such as angle-etched silicon with or without a metal coating, embedded in the upper cladding (and potentially the lower cladding 806) with one facet facing an exposed cross section of the waveguide 804. Light 812 at normal incidence on the micro-lens 802 may be coupled into the unit-cell waveguide 804 by its reflection off the micro-mirror 810. Light incident at other angles 814 on the micro-mirror 810 may be spatially separated from the micro-mirror 810 and therefore may not be reflected into the waveguide. This light may reflect back to free space or is absorbed by the substrate. The waveguide 804 may carry the light reflected from the micro-mirror 810 away to a coupling structure, such as waveguide coupler 818 before it boards the bus waveguide 820.

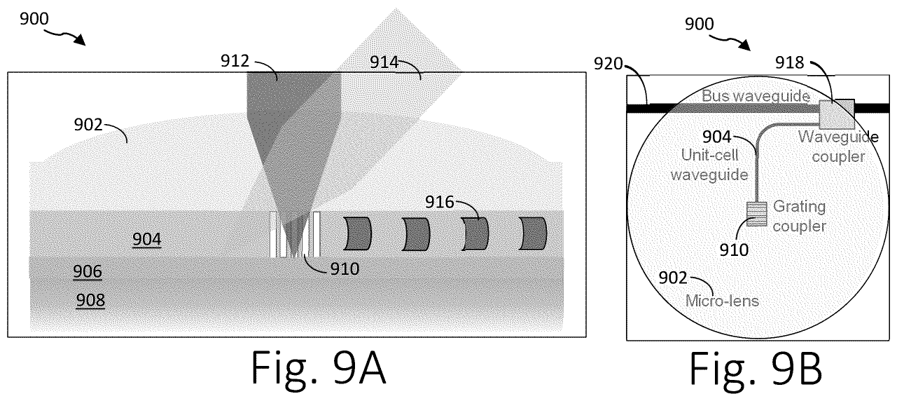

FIGS. 9A and 9B depict an alternative unit-cell in cross-section (FIG. 9A) and top-view (FIG. 9B), according to aspects of the present disclosure. According to one aspect, a grating coupler 910 may be disposed in the waveguide 904. A substrate 908 may hold a lower cladding 906 layer, a waveguide layer 904, and a micro-lens and upper cladding layer 902. The grating coupler 910 may couple light focused by the micro-lens 912 into the waveguide 904. The grating coupler 910 may include a micro- or nano-scaled pattern in the waveguide material or on top of the waveguide layer that may or may not be spatially periodic, depending on the specific embodiment. The grating coupler 910 may redirect light normally incident from free space into the unit-cell waveguide 904 and to the waveguide coupler 918 where the light may be combined into the bus waveguide 920. Light incident at other angles 914 on the micro-mirror 810 may be spatially separated from the grating coupler 910 and therefore may not be reflected into the waveguide. This light may reflect back to free space or is absorbed by the substrate.

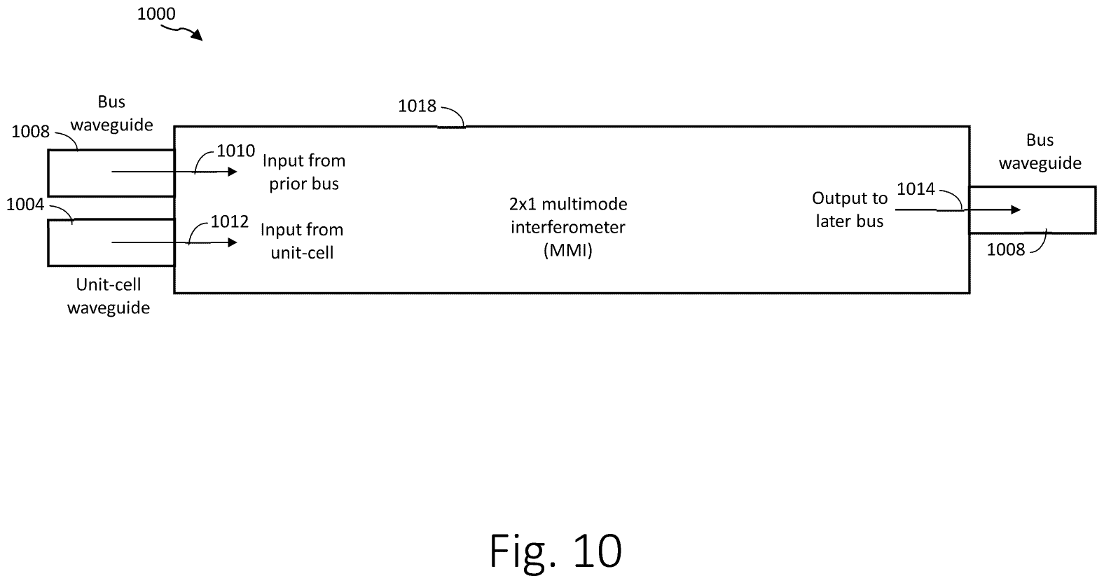

Referring now to FIG. 10, according to one aspect, a 2×1 multimode interferometer (MMI) 1018 may combine input from the bus waveguide 1008 (i.e., light from one or more prior bus cells 1010) and the input from the unit-cell 1012 on the unit-cell waveguide 1004. The MMI 1018 may take the multimode bus waveguide 1008 at a first port, and combine it with the signal from a unit-cell waveguide 1004 at the second port. The output port 1014 may carry a multimode signal that continues to the bus waveguide 1008.

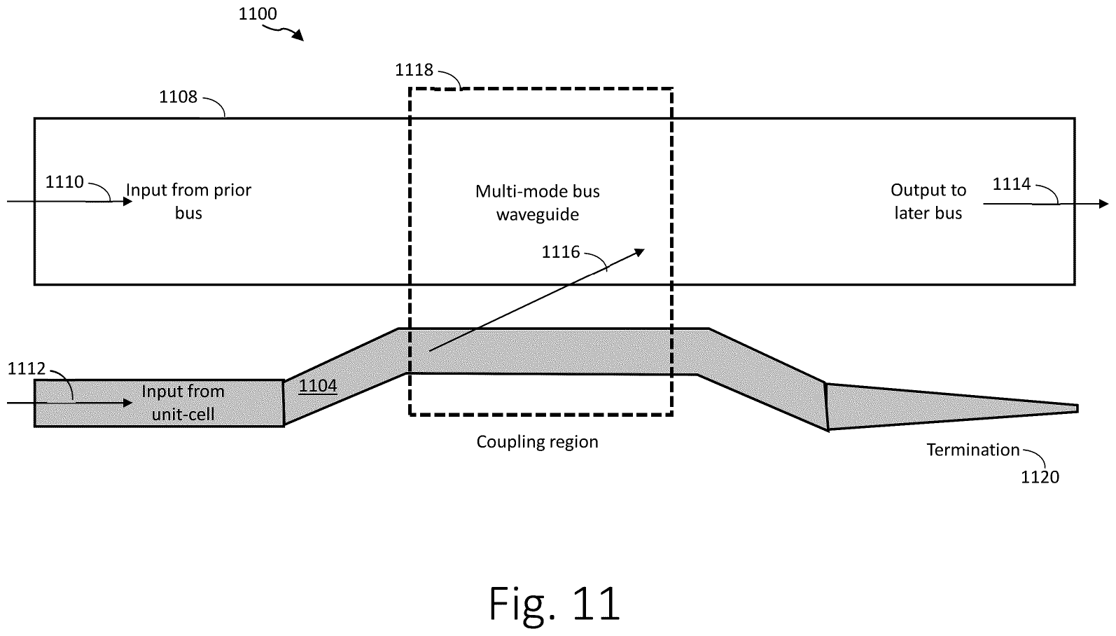

Alternatively, as shown in FIG. 11, a 2×1 evanescent waveguide coupler 1100 may transfer an input signal 1112 on a unit-cell waveguide 1104 from the unit cell to a multimode bus waveguide 1108. Such a four-port waveguide coupler uses evanescent coupling 1118 of adjacent waveguides 1108, 1104 to transfer the signal 1116 in the unit-cell waveguide 1104 to the bus waveguide 1108. The light signals passing through the bus waveguide 1108 and unit-cell waveguide 1104 may form evanescent waves by undergoing internal reflection, respectively, at their boundaries, striking them at an angle greater than the critical angle. Any signal that is not transferred may be allowed to leak into the environment to prevent unwanted reflections (termination 1120). According to one aspect, the bus waveguide 1108 may be multimode and the evanescent coupling 1118 may be transmitted to a mode that is not previously occupied so that the signal transfer 1116 is unidirectional.

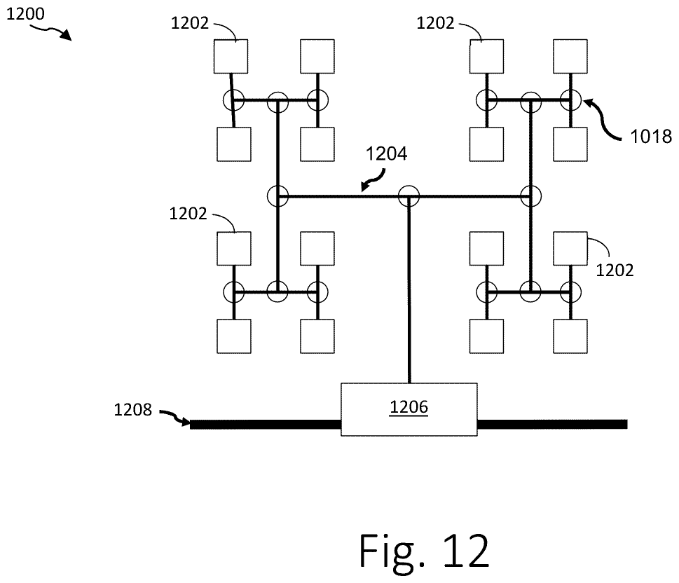

According to another aspect of the present disclosure, as shown in FIG. 12, light signals from, for example, N unit cells 1202 may be path-matched to each other and coherently combined using multiple MMIs 1018 to generate a signal in a single mode waveguide 1204 that only needs a single coupling 1206 to the bus waveguide 1208, rather than N separate couplings to the bus waveguide 1208. Pre-combining the unit-cell 1202 signals before connecting to the bus waveguide 1208 may be used in certain applications. For example, when the system is scaled to be very large this reduces the total number of modes required in the bus waveguide by N. There is a maximum number of modes supported by the multimode fiber on the way to the detector and this allows the number of participating unit cells per fiber to increase by N before hitting that limit.

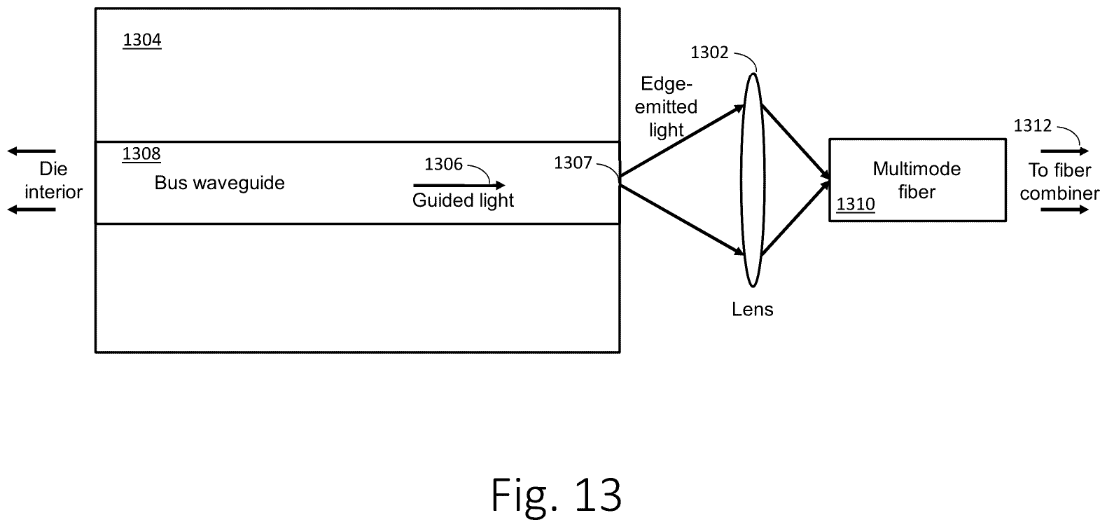

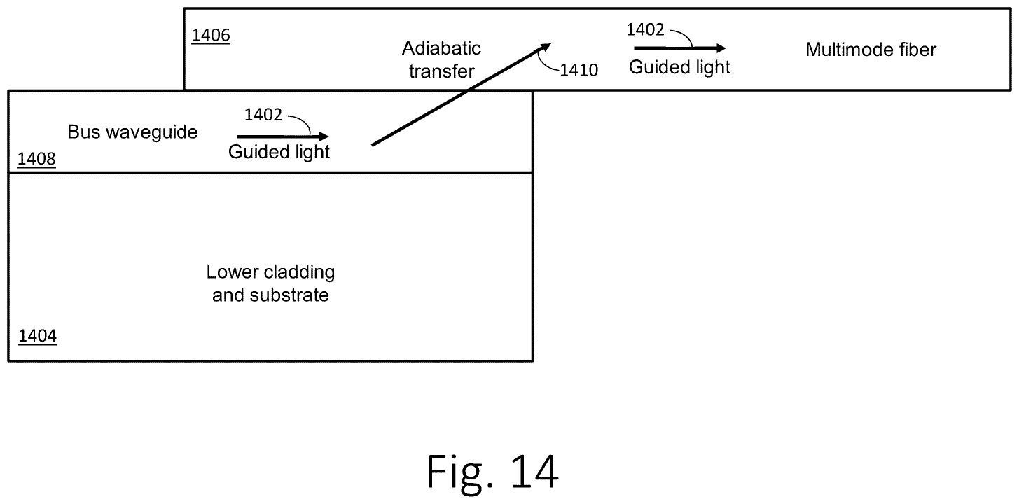

FIGS. 13 and 14 depict fiber coupling between the light-collecting devices and the multimode fiber optics carrying the die-level light signals to the fiber combiner. As shown in FIG. 13, a light-carrying device die 1304 may include guided light 1306 transmitting on the bus waveguide 1308 to the die-edge 1307 where the light will be emitted into free space. A lens 1302 may collect the edge-emitted light and couple it into a multimode fiber 1310 on its way to the fiber combiner 1312.

Alternatively, as shown in FIG. 14, guided light 1402 in the bus waveguide 1408 on light-collecting device die 1404 may be transmitted to multimode fiber 1406 by adiabatic transfer 1410. In such a transfer, the multimode fiber 1406 may contact the bus waveguide 1408 for a certain length as it approaches the edge of the die 1404. Light may transfer 1410 from the waveguide 1408 to the fiber 1406 over the length of the contact and when the die 1404 ends the fiber 1406 carries away the guided light 1402.

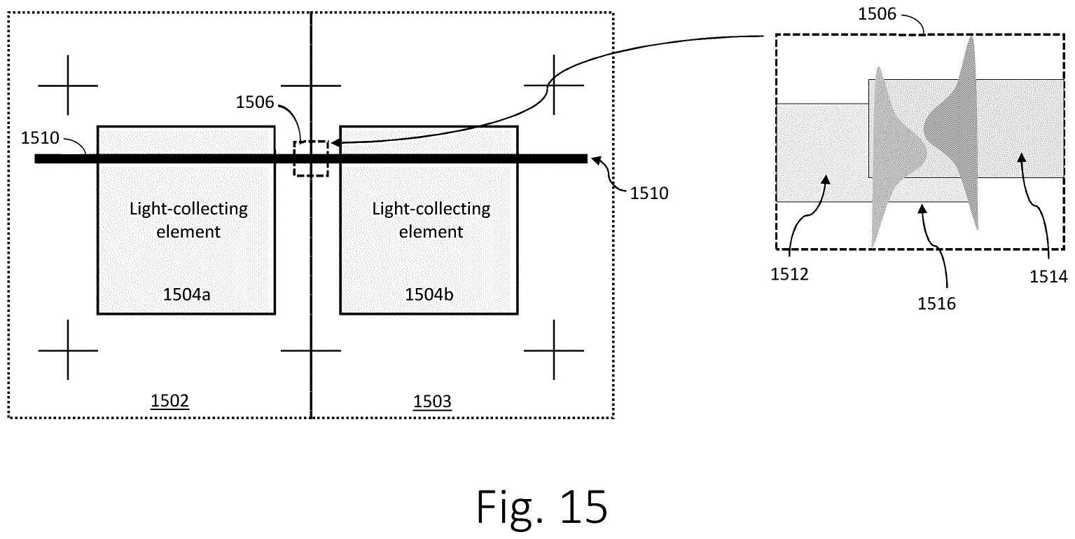

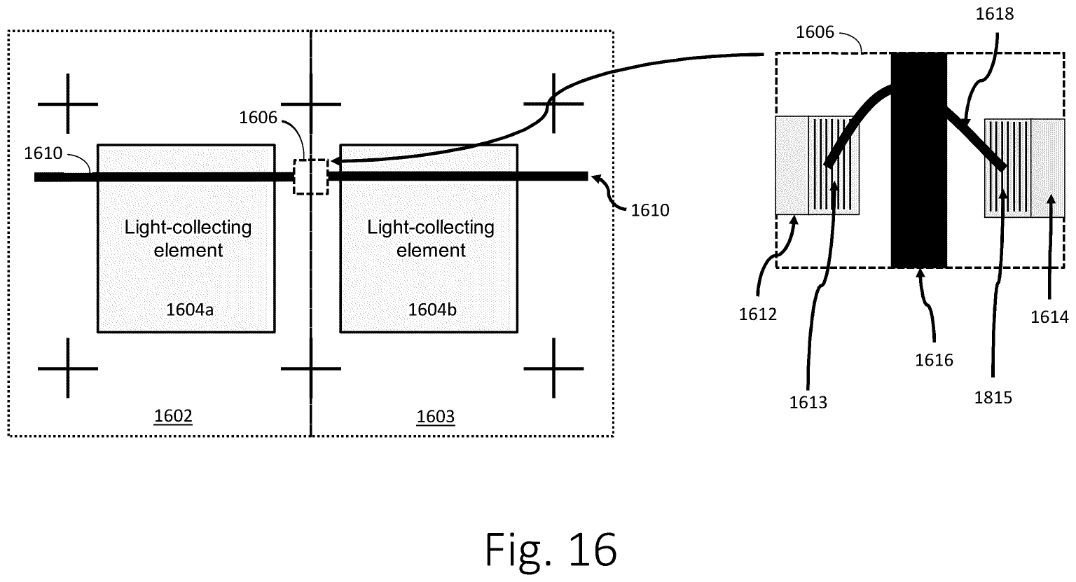

According to certain aspects, multiple reticles supporting light-collecting elements may be connected to each other before fiber coupling out. FIGS. 15 and 16, for example, illustrate chip-to-chip interconnects according to multiple aspects of the disclosure.

As shown in FIG. 15, light-collecting elements 1504a and 1504b may be disposed on reticles, 1502, 1503, respectively. According to one aspect, the light-collecting elements 1504a and 1504b may be coupled, as shown in expanded box 1506, using a waveguide structure that spills over from one reticle 1502 to the next reticle 1503. In this way, even with the potential of two-dimensional misalignment of the reticles 1502, 1503, there will be some overlap 1516 of the waveguides (waveguide region 1512 with waveguide region 1514). By using broad mode profiles, the overlap 1516 of modes between the two regions 1512, 1514 can be large, even with misalignment. According to one aspect, connecting multiple reticles in such a manner may allow scaling with low loss in applications in which low-loss waveguides are desired.

FIG. 16 depicts an alternative chip-to-chip interconnect in which a photonic wire bond 1618 couples the waveguides 1610 of a first reticle 1602 and a second reticle 1603 across a wafer dicing lane 1616. According to one aspect, light-collecting elements 1604a and 1604b may be supported by separate reticles, 1602, 1603, respectively. The inter-chip waveguide 1610 may be coupled, as shown in expanded box 1606, across a dicing lane 1616, by a photonic bonding wire 1618. According to one aspect, the waveguide regions 1612, 1614 may terminate with a grating coupler 1613, 1615, respectively, that transfers the optical signal into the photonic wire bond 1618. The photonic wire bond 1618 may usher the signal to the next reticle. The length of the photonic wire bond 1618 may be selected to control the phase of coherent signals being transferred. The material used in the photonic wire bond 1618 may also contribute to control phase. Exemplary materials for photonic wire bonds may include, without limitation, photosensitive polymers such as SU-8. According to one aspect, such an interconnection may also be implemented to fiber couple a light-collecting element die to the multimode fiber, as alternatives to free space optics (FIG. 15) or adiabatic transfer (FIG. 16).

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable sub combination. Other embodiments not specifically described herein are also within the scope of the following claims.

Various embodiments of the concepts, systems, devices, structures and techniques sought to be protected are described herein with reference to the related drawings. Alternative embodiments can be devised without departing from the scope of the concepts, systems, devices, structures and techniques described herein.

It is noted that various connections and positional relationships (e.g., over, below, adjacent, etc.) are set forth between elements in the above description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “at least one” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description herein, terms such as “upper,” “lower,” “right,” “left,” “vertical,” “horizontal, “top,” “bottom,” (to name but a few examples) and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements. Such terms are sometimes referred to as directional or positional terms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within +20% of a target value in some embodiments, within +10% of a target value in some embodiments, within +5% of a target value in some embodiments, and yet within +2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways.

Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A system comprising:
an array of light-collecting elements, each light-collecting element of the array of light-collecting elements configured to output a collected light signal to an optical fiber of a plurality of optical fibers;
an optical fiber combiner coupled to the array of light-collecting elements by the plurality of optical fibers, the optical fiber combiner configured to receive the collected light signals from the array of light-collecting elements through the plurality of optical fibers and to combine the collected light signals to form one or more combined collected light signals;
an optical detector configured to receive the one or more combined collected light signals from the optical fiber combiner and convert the one or more combined light signals into one or more electrical signals.

2. The system of claim 1 wherein each light-collecting element of the plurality of light-collecting elements includes a plurality of unit cells, each unit cell including a lens and a waveguide in-coupler for optically coupling the lens to a unit cell waveguide.

3. The system of claim 2 wherein each light-collecting element of the plurality of light-collecting elements includes a bus waveguide and a waveguide coupler configured to optically couple the unit cell waveguides of the plurality of unit cells to the bus waveguide.

4. The system of claim 3 wherein the waveguide coupler coherently couples at least some of the unit cell waveguides of the plurality of unit cells to the bus waveguide.

5. The system of claim 3 wherein each light-collecting element of the plurality of light-collecting elements includes a fiber coupling for coupling the light-collecting element's bus waveguide to an optical fiber.

6. The system of claim 1 wherein the optical fiber combiner incoherently combines the collected light signals to form the one or more combined collected light signals.

7. The system of claim 1 wherein each light-collecting element of the array of light-collecting elements includes an array of micro-lenses and a photonic integrated circuit coupled to the micro-lens array.

8. The system of claim 6 wherein the photonic integrated circuit further includes an upper cladding layer, a waveguide layer, a lower cladding layer, and a substrate.

9. The system of claim 6 wherein the array of micro-lenses has an anti-reflective coating disposed thereon.

10. The system of claim 1 wherein the optical fiber combiner is a multimode fiber combiner.

11. The system of claim 1 wherein the optical detector comprises a single-photon sensitive detector.

12. The system of claim 1 wherein the detector comprises a photo-diode.

13. The system of claim 3 wherein each lens has an aperture diameter and the system is configured to synthesize a large aperture with a diameter equal to a sum of the aperture diameters of the lenses.

14. The system of claim 13 wherein a field of view of the system, the diameter of the synthesized large aperture, and the detector area are decoupled.

15. The system of claim 2 wherein the waveguide in-coupler includes a micro-mirror coupler.

16. The system of claim 2 wherein the waveguide in-coupler includes a grating coupler.

17. The system of claim 3 wherein the waveguide coupler includes a multimode interferometer.

18. The system of claim 3 wherein the waveguide coupler includes an evanescent waveguide coupler.

19. The system of claim 1 further comprising a processor configured to process the one or more electrical signals to generate image data.

20. The system of claim 1 wherein each light-collecting element of the array of light-collecting elements has a substantially planar shape.
